(19) United States
(12) Patent Application Publication
(10) Pub. No.: US 2011/0272222 A1
(43) Pub. Date: Nov. 10, 2011

(54) HYBRID BRAKE PAD

(75) Inventors: Terry L. Heffelfinger, Lake in the Hills, IL (US); Dave Wagner, Cary, IL (US); Mark Bonasera, Algonquin, IL (US); Terry Kloster, Antioch, IL (US); John Maher, Crystal Lake, IL (US); Hiqmet Celhyka, Guelph (CA)

(73) Assignee: Brake Parts, Inc., McHenry, IL (US)

(21) Appl. No.: 12/776,122

(22) Filed: May 7, 2010

(51) Int. Cl. F16D 65/092; B23P 15/18; F16D 66/02; F16D 65/04; F16D 69/02

(52) U.S. Cl. 188/1.11 W; 188/251 A; 29/469.5

(57) ABSTRACT

A hybrid brake pad that includes a backing plate and a semi-metallic portion having a central groove. The semi-metallic portion is connected with the backing plate. A first ceramic composite portion is adjacent to the semi-metallic portion, and connecting with the backing plate. A second ceramic composite portion is opposite the first ceramic composite portion, and connecting with the backing plate.

### FIELD OF THE INVENTION

The disclosure relates to a pad for a disk brake, and in particular to a hybrid brake pad.

### DESCRIPTION OF THE RELATED ART

Vehicle manufacturers design towards increasing efficiency (e.g., mileage) and one area of focus is reducing air-drag. The under-vehicle air-drag is also being optimized. One method to reduce under-vehicle drag is to seal the undercarriage off from disruptive drafts and airflow in the engine compartment, drive-line, wheel wells, and gas tank vents. The evolution of the increased efficiency improves the Corporate Average Fuel Economy (“CAFÉ”) requirements, but does little to help with ventilation of under-vehicle areas. In particular, there is less cooling or drying effects in the brake rotor and brake drum area. This leads to rusting and other problems with components.

When ceramic friction material formulations are used in brake pads, they may leave a coating on the rotor surface. Due to reduced airflow in the under-vehicle areas, moisture is able to get underneath the layer of ceramic deposit. Over time, this causes rusting, and then blistering to occur because the ventilation is poor. In addition, where salt and/or chlorides are used to remove winter snow and ice, there may be increased rusting and intrusion under the ceramic deposits.

Thus, it is desired to have superior braking properties of the ceramic composite material brake pads, but to reduce the rusting caused by reduced air flow and reduced drying of under-vehicle components, to condition the rotor, and to reduce the ceramic deposits.

### SUMMARY

A hybrid brake pad that includes a backing plate and a semi-metallic portion having a central groove. The semi-metallic portion is connected with the backing plate. A first ceramic composite portion is adjacent to the semi-metallic portion, and connecting with the backing plate. A second ceramic composite portion is opposite the first ceramic composite portion, and connecting with the backing plate. The hybrid brake pad may also include a wear indicator layer between the backing plate and the semi-metallic portion. The wear indicator layer may be positioned between the backing plate and the first and second ceramic composite portions. The semi-metallic portion may be of a single-piece construction, and having a first half, a second half, and a connecting portion.

The first ceramic portion and the second ceramic portion may be entirely separated by the semi-metallic portion. The semi-metallic portion may include steel fibers. The first ceramic composite portion and the second ceramic composite portion may include ceramic, aramid, Kevlar® (a registered trademark of E.I. du Pont de Nemours and Company) or glass fibers. The first ceramic composite portion and the second ceramic composite portion may include non-metallic fibers. The hybrid brake pad may also include an underlayer that bonds the backing plate to the first ceramic composite portion, the second ceramic composite portion, the semi-metallic portion. The first ceramic composite portion and the second ceramic composite portion may also be bonded to the semi-metallic portion.

A method of making a hybrid brake pad using a press may include providing a backing plate, placing the backing plate into the press, providing a pre-form insert, placing the pre-form insert into the press over the backing plate, providing friction material, placing the friction material into the press, and engaging the press. The method may also include placing an underlayer material over the backing plate when it is in the press, and before placing the preform insert. The method may further include placing a wear indicator material mixed in the underlayer material, and before placing the preform insert.

The method may also include a mold that forms a central groove in the pre-form insert. The method may also include a mold that forms the shape of the friction material and the pre-form insert. The hybrid brake pad product may also be prepared by the process discussed herein.

### BRIEF DESCRIPTION OF THE DRAWINGS

The disclosure will now be described, by way of example, with reference to the accompanying drawings, in which:

FIG. 1 is a perspective view of a hybrid brake pad.

FIG. 2 is a front view of the hybrid brake pad according to FIG. 1.

FIG. 3 is a side view of the hybrid brake pad according to FIG. 1.

FIG. 4 is a perspective view of an exemplary insert for the hybrid brake pad of FIG. 1.

FIG. 5 is an example of a positive mold press manufacturing process for making the hybrid brake pad 10.

FIG. 6 is an example of a flash-press manufacturing process for making the hybrid brake pad 10.

### DETAILED DESCRIPTION OF THE INVENTION

The Figures illustrate an exemplary embodiment of a hybrid brake pad in accordance with an embodiment of the invention. Based on the foregoing, it is to be generally understood that the nomenclature used herein is simply for convenience and the terms used to describe the invention should be given the broadest meaning by one of ordinary skill in the art.

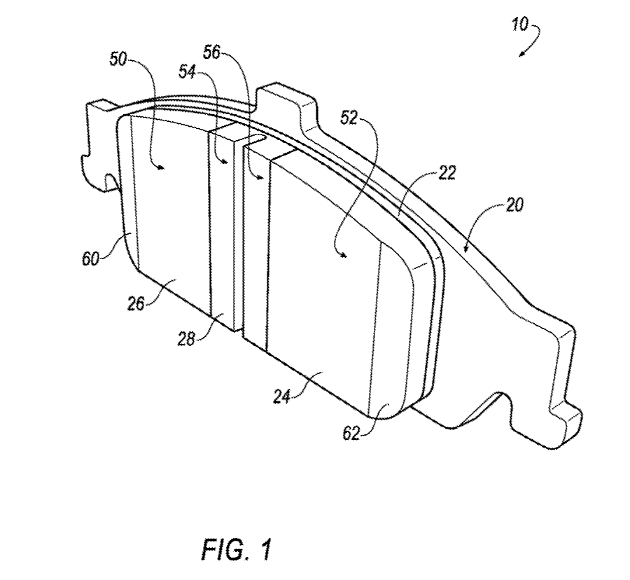

FIG. 1 is a perspective view of a hybrid brake pad 10. In an example, hybrid brake pad 10 may include a first braking surface 50, a second braking surface 52 and an insert 28. The hybrid brake pad 10 may also include supporting structures such as a backing plate 20 and a wear indicator layer 22. However, other supporting structures may be used such as where the brake pad is used in alternative braking systems. Other layers, materials and/or bonding agents may be placed between or partially between any of the components.

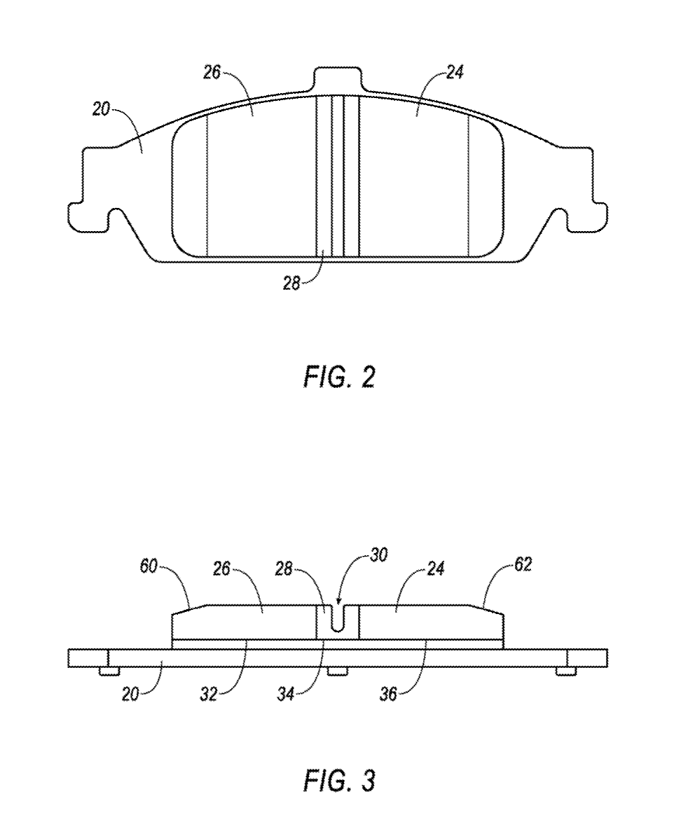

Referring now to FIGS. 1-3, backing plate 20 may comprise a stamped metal part made of, for example, steel or a steel alloy. The wear indicator layer 22 may be applied over the top of backing plate 20 to form a substrate for the primary braking materials, shown as first a pad 24, a second pad 26, and an insert 28. Wear indicator layer 22 is optional and need not be present as part of hybrid brake pad 10.

Insert 28 may be a different material than first pad 24 and/or second pad 26. Thus, the material properties and the braking and frictional relationship between insert 28 and a brake rotor (not shown) may have predetermined characteristics that are different than first pad 24, and second pad 26. In an example, insert 28 may be chosen as a semi-metallic material and first pad 24 and second pad 26 may be chosen as ceramic composite. Thus, the hybrid brake pad 10 has both the braking properties of the ceramic composite material and the semi-metallic. As shown in FIG. 1, a first braking surface 50, and a second braking surface 52 are greater than a first insert braking surface 54 and a second insert braking surface 56. This provides more surface area and properties of the ceramic composite material but also provides for some surface area and properties of the semi-metallic material.

To reduce rust-jacking, the semi-metallic material of insert 28 frictionally engages the brake disk at first insert braking surface 54 and second insert braking surface 56. This frictional interface provides for enhanced rotor cleaning in comparison to a typical ceramic composite brake pad. The semi-metallic material engages the brake disk and provides a cleaning action when in use. In an example where first pad 24 and second pad 26 are ceramic-composite materials, and insert 28 is a semi-metallic material, the semi-metallic material cleans the rotor while the ceramic composite provides low dust, low noise and increased performance. These benefits continuously condition the rotor for maximum braking efficiency throughout the friction life cycle, while maintaining the advantages of low dust, low noise and high performance.

In general, first braking pad 24 and second braking pad 26 may comprise a ceramic composite material. For example, it may include non-metallic or ceramic fibers within the brake pad material. An example of a non-metallic fiber is fiberglass. The insert 28 may comprise a semi-metallic material that includes steel fibers. The metallic fibers and non-metallic fibers generally distinguish between a non-metallic or ceramic composite material and a semi-metallic material. In this example, steel fibers vs. fiberglass. However, both the ceramic composite material and semi-metallic material may include other copper, which provides adhesive friction and a high thermal conductivity in the system. One of ordinary skill in the art will recognize that the simple presence of a metallic in a ceramic composite does not make that composite a semi-metallic friction material.

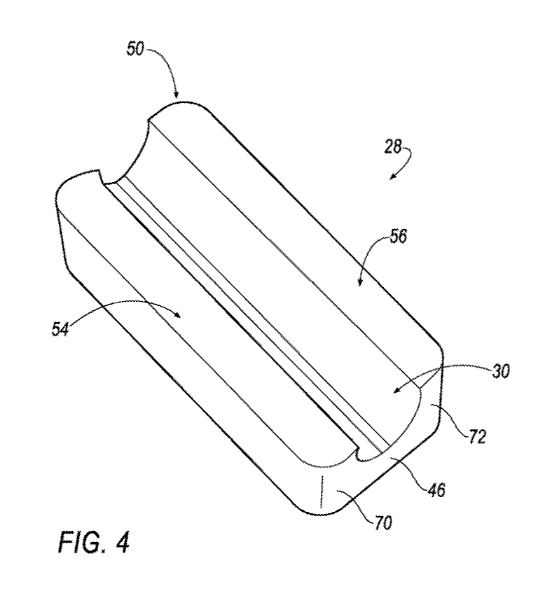

Referring now to FIGS. 3 and 4, a central groove 30 provides an escape path for wear debris so that material (e.g., dust) can evacuate out and away from the frictional surfaces. Moreover, central groove 30 provides a stress relief so that when hybrid brake pad 10 heats up it does not crack. In the example shown, insert 28 has a single central groove 30. However, there may also be grooves through first braking pad 24 and second braking pad 26, and there may be additional perpendicular grooves or grooves in a cross-hatch pattern.

Wear indicator layer 22 may include hard or noise-making materials that produce a sound when they come in contact with the brake rotor. This provides the vehicle operator with an indication that the first pad 24, second pad 26, and/or insert 28 have substantially worn through and it is time to replace the brake pad.

FIG. 4 shows insert 28 in a perspective view. Insert 28 may comprise first insert braking surface 54 and second insert braking surface 56 for frictionally engaging the brake rotor. As insert 28 wears, a first half 72 and a second half 70 wear down. Thus, surfaces 54, 56 are not permanently positioned but rather move as the insert 28 wears. When insert 28 is made as a pre-form, it may include rounded edges 50 depending on the shape of the form. However, the edges may also be substantially may also be square, but may be re-shaped during production processes. A connecting portion 46 mates the first half 72 and a second half 70 and provides for the central groove 30.

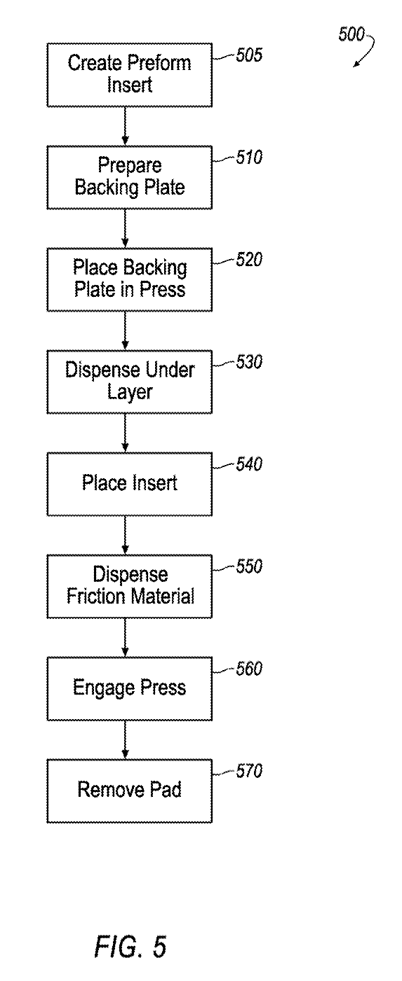

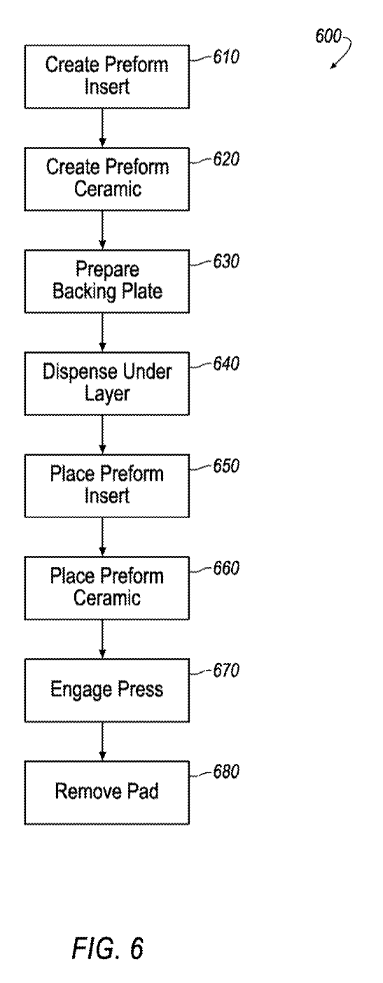

In manufacturing the hybrid brake pad 10, the insert 28 may be made as a pre-form of semi-metallic material, and may be dropped in the center of a positive mold press for manufacturing. Alternatively, the hybrid brake pad 10 may be manufactured using a flash-press with two distinct preforms, one of semi-metallic material for the insert 28 and another for each of first braking pad 24 and second braking pad 26. In each of the manufacturing processes of FIGS. 5 and 6 below, the friction materials comprising first braking pad 24, second braking pad 26, and insert 28, are bonded to each other as shown in the foregoing drawings, as well as to the backing plate and/or the underlayer/wear indicator layer 22.

FIG. 5 is an example of a positive mold press manufacturing process for making the hybrid brake pad 10.

In step 505, a preform insert may be created. In a separate mold, the preform material (e.g., semi-metallic material) may be added to a mold and formed. The material may be a loose material that may be placed into a mold and pressed and formed. However, the material is typically not baked so as to maintain the insert as a loosely held mix. The material may also comprise additives to hold the preform insert together while transporting it to the main press (e.g., in step 540 below), or while it is stored for later use.

In step 510, a backing plate 20 may be prepared. The backing plate 20 is typically a metallic material such as steel, and may be prepared by washing, blasting, or abrading the surface to assist in bonding the other materials to it.

In step 520, the backing plate 20 may be placed in a positive mold press.

In step 530, an underlayer may be dispensed into the positive mold press. The underlayer is an optional layer of material that assists bonding of the backing plate 20. The underlayer may also comprise wear indicator layer 22 that may include materials to make noise when in contact with the brake rotor. The wear indicator material may be part of wear indicator layer 22.

In step 540, the insert 28 may be placed into the press and over the optional underlayer/wear indicator layer 22. The loosely held together insert 28 may be placed substantially at the desired final position over the backing plate 20. Once pressed, the insert 28 may not be relocated in the hybrid brake pad 10.

In step 550, the friction material may be dispensed into the press. In a positive mold press, the friction material (e.g., ceramic composite material) may be dispensed from a hopper or a measuring tool. The friction material may be loose mix of materials that will form first pad 24 and second pad 26 after the manufacturing process is complete.

In step 560, the press may be engaged. The press may be held at a predetermined temperature, for a predetermined time, and under a predetermined pressure. Moreover, the thermal curve of the press may be adjusted to compensate for the material properties of the friction material, insert material, and/or underlayer material. The insert 28 stays at substantially the same position as when it was placed in the mold, and the mold cavity may form central groove 30 (see FIGS. 3 and 4).

In step 570, the finished pad may be removed. The pad may be cooled for a period of time or it may be further cured at a predetermined heat profile.

FIG. 6 is an example of a flash-press manufacturing process for making the hybrid brake pad 10.

In step 610, a preform insert may be created. In a separate mold, the preform material (e.g., semi-metallic material) may be added to a mold and formed. The material may be a loose material that may be placed into a mold and pressed and formed. However, the material is typically not baked so as to maintain the insert as a loosely held mix. The material may also comprise additives to hold the preform insert together while transporting it to the main press (e.g., in step 540 below), or while it is stored for later use.

In step 620, a ceramic preform may be created. In a separate mold, the ceramic preform material (e.g., ceramic composite material) may be added to a mold and formed. The material may be a material that may be placed into a mold and pressed and formed. However, the material is typically not baked so as to maintain the insert as a loosely held mix. The material may also comprise additives to hold the preform insert together while transporting it to the main press (e.g., in step 540 below), or while it is stored for later use.

In step 630, the backing plate 20 may be placed in a flash mold press.

In step 640, an underlayer may be dispensed into the flash mold press. The underlayer is an optional layer of material that assists bonding of the backing plate 20. The underlayer may also comprise wear indicator layer 22 that may include materials to make noise when in contact with the brake rotor. The wear indicator material may be part of wear indicator layer 22.

In step 650, the insert 28 may be placed into the press and over the optional underlayer/wear indicator layer 22. The loosely held together insert 28 may be placed substantially at the desired final position over the backing plate 20. Once pressed, the insert 28 may not be relocated in the hybrid brake pad 10.

In step 660, the ceramic preforms may be placed in the press. The ceramic preforms may each be placed to the side of insert 28. The press will locate and bond the preforms to each other, and to the backing plate 20.

In step 670, the press may be engaged. The press may be held at a predetermined temperature, for a predetermined time, and under a predetermined pressure. Moreover, the thermal curve of the press may be adjusted to compensate for the material properties of the friction material, insert material, and/or underlayer material. The insert 28 stays at substantially the same position as when it was placed in the mold, and the mold cavity may form central groove 30 (see FIGS. 3 and 4).

In step 680, the finished pad may be removed. The pad may be cooled for a period of time or it may be further cured at a predetermined heat profile.

The present invention has been described with reference to certain exemplary embodiments thereof. However, it will be readily apparent to those skilled in the art that it is possible to embody the invention in forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A hybrid brake pad, comprising:
a backing plate;
a semi-metallic portion having a central groove, and connecting with the backing plate;
a first ceramic composite portion adjacent to the semi-metallic portion, and connecting with the backing plate; and
a second ceramic composite portion opposite the first ceramic composite portion, and connecting with the backing plate.

2. The hybrid brake pad according to claim 1, further comprising:
a wear indicator layer between the backing plate and the semi-metallic portion.

3. The hybrid brake pad according to claim 2, further comprising:
a wear indicator layer between the backing plate and the first and second ceramic composite portions.

4. The hybrid brake pad according to claim 1, wherein the semi-metallic portion is of a single-piece construction, and having a first half, a second half, and a connecting portion.

5. The hybrid brake pad according to claim 1, wherein the first ceramic portion and the second ceramic portion are entirely separated by the semi-metallic portion.

6. The hybrid brake pad according to claim 1, wherein the semi-metallic portion comprises steel fibers.

7. The hybrid brake pad according to claim 1, wherein the first ceramic composite portion and the second ceramic composite portion comprise at least one of ceramic, aramid, Kevlar or glass fibers.

8. The hybrid brake pad according to claim 1, wherein the first ceramic composite portion and the second ceramic composite portion comprise non-metallic fibers.

9. The hybrid brake pad according to claim 1, further comprising an underlayer that bonds the backing plate to the first ceramic composite portion, the second ceramic composite portion, the semi-metallic portion.

10. The hybrid brake pad according to claim 1, wherein the first ceramic composite portion and the second ceramic composite portion are bonded to the semi-metallic portion.

11. A method of making a hybrid brake pad using a press, comprising:
providing a backing plate;
placing the backing plate into the press;
providing a pre-form insert;
placing the pre-form insert into the press over the backing plate;
providing friction material;
placing the friction material into the press; and
engaging the press.

12. The method of claim 11, further comprising:
placing an underlayer material over the backing plate when it is in the press, and before placing the preform insert.

13. The method of claim 12, further comprising:
placing a wear indicator material within the underlayer material, and before placing the preform insert.

14. The method of claim 11, further comprising:
placing a wear indicator layer material over the backing plate when it is in the press, and before placing the preform insert.

15. The method of claim 11, further comprising:
a mold that forms a central groove in the pre-form insert.

16. The method of claim 11, further comprising:
a mold that forms the shape of the friction material and the pre-form insert.

17. A hybrid brake pad prepared by a process comprising the steps of:
providing a backing plate;
placing the backing plate into the press;
providing a pre-form insert;
placing the pre-form insert into the press over the backing plate;
providing friction material;
placing the friction material into the press; and
engaging the press.

18. The hybrid brake pad prepared by the process of claim 17, further comprising:
placing an underlayer material over the backing plate when it is in the press, and before placing the preform insert.

19. The hybrid brake pad prepared by the process of claim 18, further comprising:
placing a wear indicator material within the underlayer material, and before placing the preform insert.

20. The hybrid brake pad prepared by the process of claim 19, further comprising:
placing a wear indicator layer material over the backing plate when it is in the press, and before placing the preform insert.
